(19) United States
(12) Patent Application Publication
(10) Pub. No.: US 2013/0286291 A1
(43) Pub. Date: Oct. 31, 2013

(54) TELEVISION RECEIVER AND ELECTRONIC DEVICE

(71) Applicant: KABUSHIKI KAISHA TOSHIBA, Tokyo (JP)

(72) Inventor: Atsuhiro YANAGIDA, Hamura-shi (JP)

(73) Assignee: KABUSHIKI KAISHA TOSHIBA, Tokyo (JP)

(21) Appl. No.: 13/683,463

(22) Filed: Nov. 21, 2012

(30) Foreign Application Priority Data
Apr. 25, 2012 (JP) 2012-099732

(51) Int. Cl. H04N 5/44

(52) U.S. Cl. CPC H04N 5/44
USPC 348/725

(57) ABSTRACT

According to one embodiment, a television receiver includes a casing that receives a display unit. The display unit includes a reinforcing frame at its peripheral portion. A plurality of elastic members are provided between the casing and the display unit at positions at which the elastic members overlap with an inner edge of the reinforcing frame.

### CROSS-REFERENCE TO RELATED APPLICATIONS

This application is based upon and claims the benefit of priority from prior Japanese Patent Application No. 2012-099732, filed Apr. 25, 2012, the entire contents of which are incorporated herein by reference.

### FIELD

Embodiments described herein relate generally to a television receiver and an electronic device, such as a portable computer, which are provided with a display unit, such as a liquid crystal display unit.

### BACKGROUND

In general, a notebook portable computer (note PC) has a structure in which a display panel is connected to one end of a PC proper via a hinge mechanism such that it is openable and closable. The display panel has a structure in which a display unit is received within the backside cover of the panel, and a mask is provided around the front side of the display unit.

When the display unit is received within the backside cover of the display panel, an elastic member is interposed between the inner surface of the backside cover and the rear side of the display unit in order to absorb external impact that will occur when the note PC is dropped. Thus, the display unit is held on the inner surface of the backside cover using the elastic member.

However, the elastic member provided for the purpose of absorbing impact is often divided into several portions, and these portions are provided separately from each other. Therefore, when the mask is pressed from the front side, stress concentration may well occur in the portion of the mask at which no elastic member is provided, thereby causing, for example, a crack in the display unit.

There is a need for development of a television receiver and an electronic device capable of reliably holding the display unit.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating the appearance of a television receiver according to an embodiment;

FIG. 2 is an exemplary perspective view illustrating the appearance of a note PC according to another embodiment;

FIG. 3 is an exemplary exploded perspective view illustrating the display panel of the note PC shown in FIG. 2;

FIG. 4 is an exemplary plan view as viewed from the inside of the backside cover shown in FIG. 3;

FIG. 5 is an exemplary schematic view useful in explaining the layout of the elastic member shown in FIG. 4;

FIG. 6 is an exemplary schematic view illustrating the positional relationship of the display unit with respect to the elastic member shown in FIG. 5;

FIG. 7 is an exemplary view taken along line F7-F7 of FIG. 6; and

FIG. 8 is an exemplary view taken along line F8-F8 of FIG. 6.

### DETAILED DESCRIPTION

Various embodiments will be described hereinafter with reference to the accompanying drawings.

In general, according to one embodiment, a television receiver has a casing with a display unit received therein. The display unit has a reinforcing frame on a periphery thereof. An elastic member is provided between the casing and the display unit on the inner edge of the reinforcing frame.

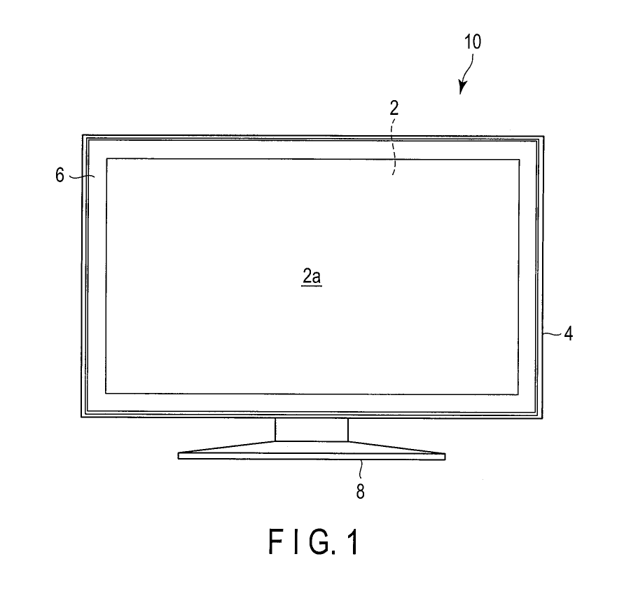

FIG. 1 is a view illustrating the appearance of a television receiver 10 according to the embodiment.

The television receiver 10 comprises a display unit 2 such as a liquid crystal display (LCD), a backside cover 4 (casing) that covers the lateral sides and backside (the backside indicates the surface of the display unit 2 opposite to a display screen 2a thereof) of the display unit 2, and a mask 6 as a rectangular frame provided on the front surface of the display unit 2. The television receiver 10 also comprises a stand assembly 8 fixed to an underbody (not shown) interposed between the display unit 2 and the backside cover 4.

The display unit 2 is formed flat and substantially rectangular. The display unit 2 comprises a transparent front panel of glass provided on the display screen 2a, and a reinforcing metal frame (not shown) provided on the periphery of the display unit 2. The reinforcing frame has an edge overlapping with the display screen 2a along the edge of the front panel. The display unit 2 receives a video signal from a video signal processing circuit incorporated in a control circuit formed of, for example, electronic elements mounted on a board, which are not shown, and displays still and/or moving images.

As well as the video signal processing circuit, the control circuit of the television receiver 10 comprises elements (not shown), such as a tuner, a high-definition multimedia interface (HDMI) signal processing unit, an audio video (AV) input terminal, a controller, a selector, an on-screen display interface, storing units (e.g., a read only memory (ROM)), a random access memory (RAM), a hard disk drive (HDD), a voice signal processing circuit, etc. The television receiver 10 also comprises a voice output amplifier and loud speaker (not shown).

The backside cover 4 has a substantially rectangular frame-shaped peripheral wall having at least a portion thereof opposed to the lateral surfaces of the display unit 2, and a substantially rectangular bottom covering the backside of the display unit 2. In the embodiment, the peripheral wall extends continuously to surround the entire circumference of the display unit 2. A frame-shaped elastic member (not shown) is attached to the inner surface of the bottom of the backside cover 4. The elastic member continuously extends along the peripheral wall of the cover 4, inwardly slightly away from the peripheral wall.

The frame-shaped elastic member overlaps with the inner edge of the reinforcing frame provided along the peripheral portion of the display unit 2 (this edge overlaps with the display screen 2a). By virtue of this structure, if the mask 6 is pressed when, for example, the television receiver 10 is carried, concentration of stress in the boundary between the edge of the reinforcing frame and the display unit 2 is avoided, thereby preventing the front panel of the display unit 2 from cracking at the boundary.

Further, the elastic member also functions as a spacer for compensating for differences in thickness when display units of different thicknesses are attached to backside covers 4 of the same thickness. Accordingly, the elastic member must have a hardness that can stabilize the mounting position of the display unit along the thickness of the display unit. Namely, it is insufficient if the elastic member merely has elasticity for absorbing an external force. The structure and function of the elastic member will be described later in detail.

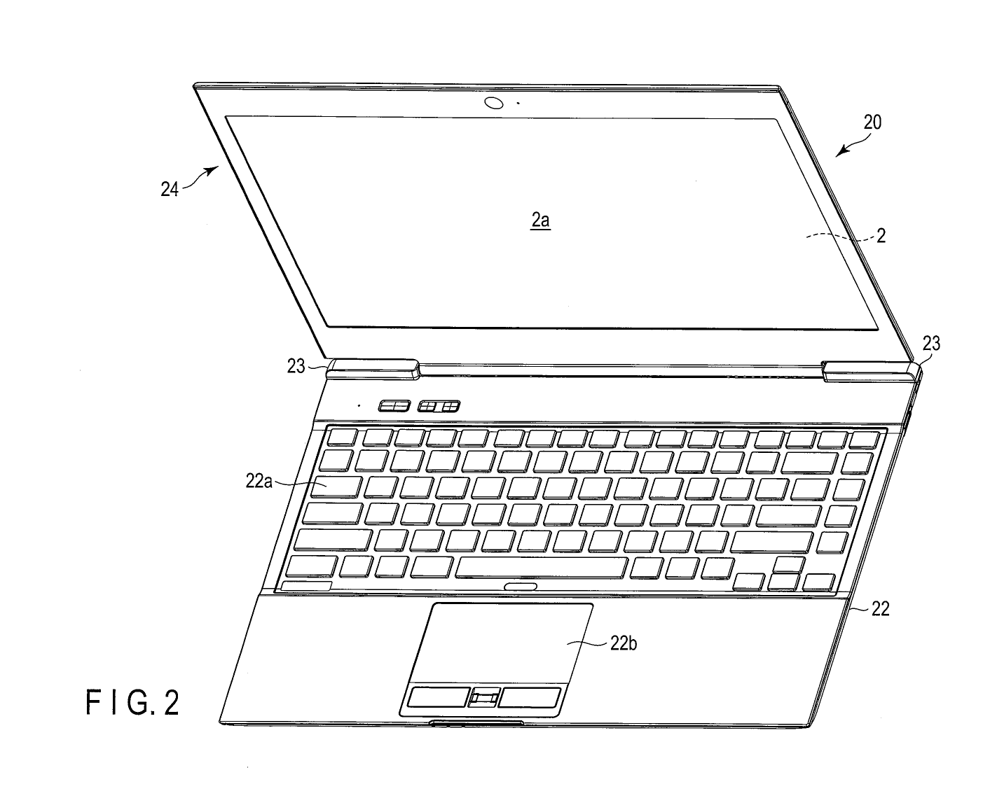

FIG. 2 is a perspective view illustrating the appearance of a notebook personal computer 20 (hereinafter, a note PC 20) according to the embodiment. FIG. 2 shows a state in which a display panel 24 incorporated in the note PC 20 is open to its PC proper 22. More specifically, the display panel 24 is rotatably attached to the rear end of the PC proper 22 via two hinges 23 so that it can assume such an open state as shown, or a closed state in which it closes the upper surface of the PC proper 22.

As shown in FIG. 2, a keyboard 22a and a touch pad 22b are provided on the upper surface of the PC proper 22 to be covered with the display panel 24. The display screen 2a of the display unit 2 is exposed through the central recess of the display panel 24. Namely, when the display screen 2a of the display panel 24 is made to overlap with the upper surface of the PC proper 22 (not shown), the display screen 2a opposes the keyboard 22 and the touch pad 22.

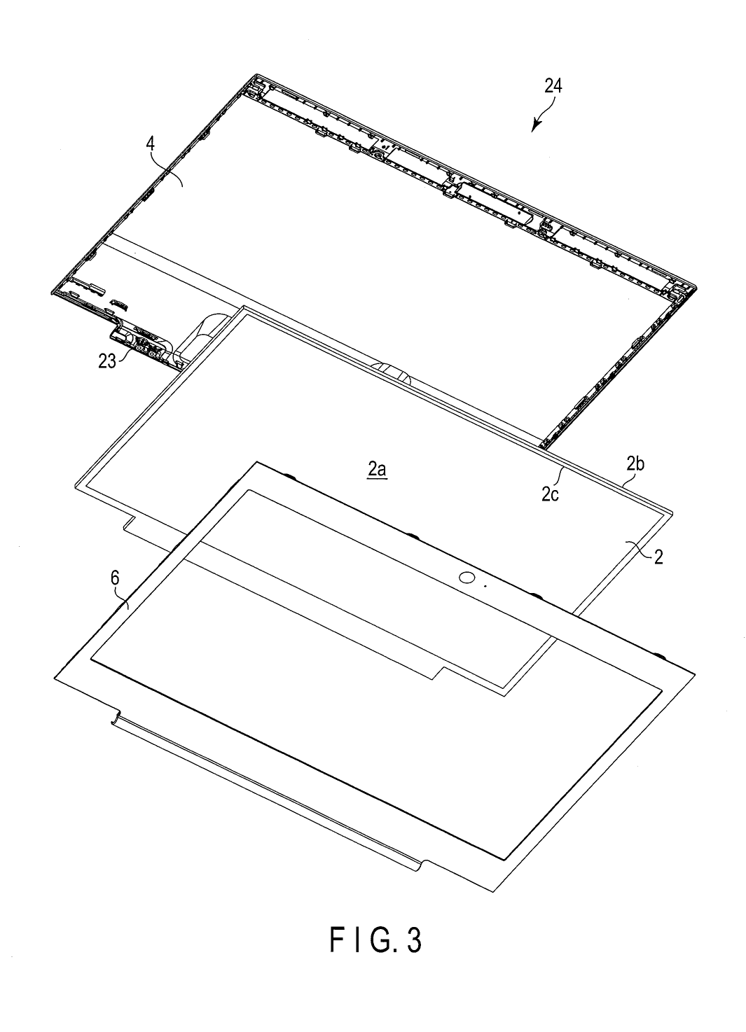

FIG. 3 is an exploded perspective view as viewed from the front side of the display panel 24. The display panel 24 comprises a substantially rectangular display unit 2 (unit), a backside cover 4 (casing) covering the lateral sides and backside of the display unit 2, and a rectangular mask 6 covering the peripheral portion of the display screen 2a of the display unit 2. The display unit 2, the backside cover 4 and the mask 6 have substantially the same functions as the corresponding elements of the previously described television receiver 10.

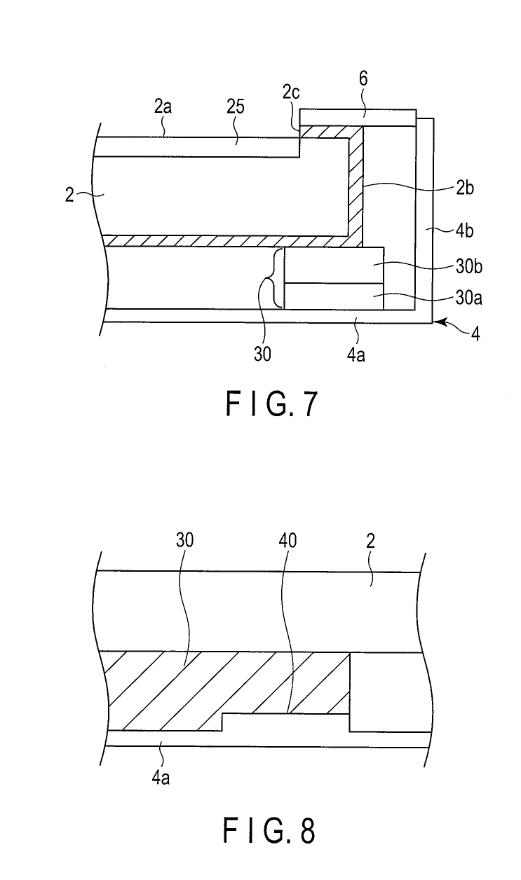

The display unit 2 has a front panel 25 (see FIG. 7) formed of transparent glass and provided on the display screen 2a side. The display unit 2 also has a substantially rectangular reinforcing frame 2b of a metal at a periphery thereof. The reinforcing frame 2b includes a rectangular inner edge 2c overlapping with the display screen 2a at the periphery of the front panel 25. The display unit 2 displays an image corresponding to an input operation performed via the keyboard 22a and the touch pad 22b located on the upper surface of the PC proper 22.

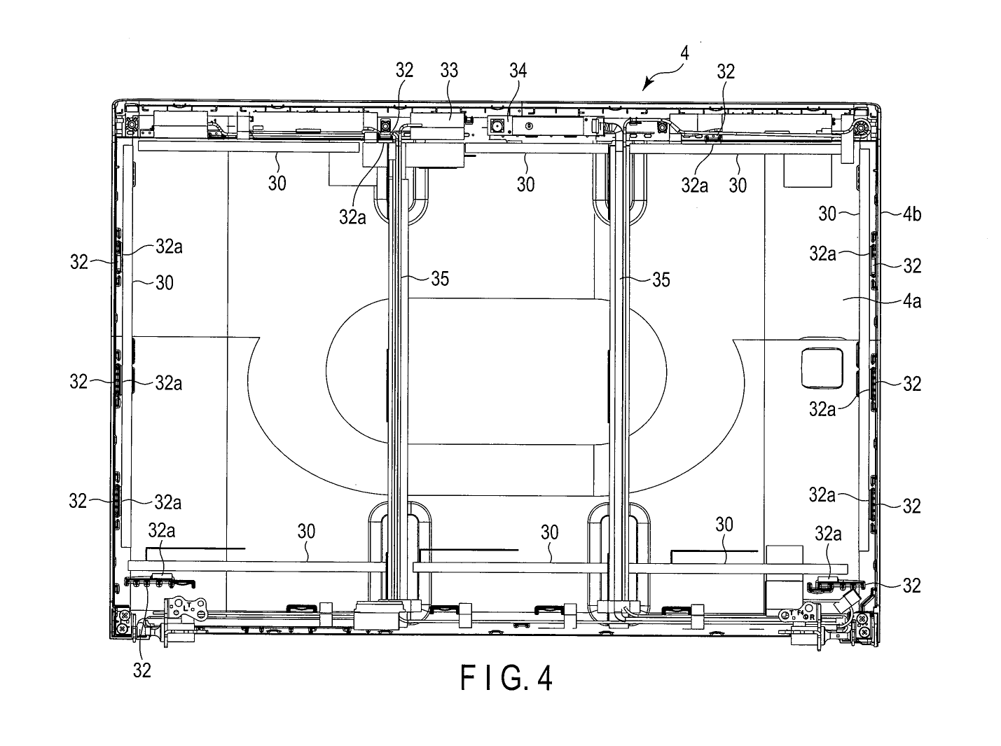

FIG. 4 is a plan view as viewed from inside the backside cover 4, i.e., from the display unit 2 side. The backside cover 4 comprises a bottom 4a opposing the backside of the display unit 2, and a substantially rectangular peripheral wall 4b extending from the periphery of the bottom 4a. The peripheral wall 4b opposes side surfaces of the display unit 2, i.e., opposes, with a certain gap, the side surfaces of the reinforcing frame 2b provided on the peripheral edge of the display unit 2.

A plurality of slender elastic members 30 are provided on the inner surface of the bottom 4a of the backside cover 4 along the peripheral wall 4b and inwardly away from the peripheral wall 4b. The elastic members 30 are arranged substantially continuously to substantially form a frame. Further, when the display unit 2 is fitted in the backside cover 4, the elastic members 30 overlap with the inside edge of the reinforcing frame 2b provided along the peripheral portion of the display unit 2. The inside edge of the reinforcing frame 2b is the edge 2c of the reinforcing frame 2b overlapping with the display screen 2a of the display unit 2. It is desirable that the elastic members 30 provide a continuous frame.

A plurality of ribs 32 project from the inner surface of the bottom 4a of the backside cover 4 outside the elastic members 30 and inwardly away from the peripheral wall 4b of the backside cover 4. When the display unit 2 is fitted in the backside cover 4 with the peripheral portion of the backside of the display 2 kept in contact with the elastic members 30, the ribs 32 oppose the sides of the reinforcing frame 2b provided along the peripheral portion of the display unit 2. Buffer members 32a are attached to the inner surfaces of the ribs 32 opposing the side surfaces of the display 2.

Namely, when the display unit 2 is placed within the backside cover 4, the side surfaces of the reinforcing frame 2b provided along the peripheral portion of the display unit, i.e., the side surfaces of the display unit 2, are guided by the ribs 32 so that the backside peripheral portion (substantially the reinforcing frame 2b) of the display unit 2 is mounted on the elastic members 30.

In this state, the elastic members 30 attached to the bottom 4a of the backside cover 4 contact and support the backside of the display unit 2 at the peripheral portion thereof, thereby positioning the display unit 2 at a predetermined mounting position along the thickness of the display unit 2. Further, in this state, the buffer members 32a attached to the inner surfaces of the ribs 32 hold the side surfaces of the display unit 2 in a buffering manner.

Thus, the display unit 2 is positioned by means of the plurality of elastic members 30 and buffer members 32a and held in a buffering manner within the backside cover 4. This structure enables the display unit 2 to be held within the backside cover 4 without screwing the display unit 2 to the cover 4.

At this time, the elastic members 30 basically function as spacers. Namely, when display units of different thicknesses are attached to backside covers 4 of the same size, spacers are necessary to compensate for differences in thickness. In the embodiment, to attach the display unit 2 that is relatively thin, to the backside cover 4 that is relatively thick, the elastic members 30 functioning as spacers are needed. In this case, the display unit 2 is thinner than a display unit of a thickness that does not require the elastic members 30. Therefore, the display unit 2 may be mechanically weaker than the latter.

To reliably hold the thin display unit 2 within the backside cover 4, it is desirable to provide elastic member of a great area that can fill the whole space between the bottom 4a of the backside cover 4 and the backside of the display unit 2. Actually, however, if the area of elastic member 30 is increased, the cost is increased accordingly, and the note PC is increased in weight. Therefore, it is necessary to set the size and position of each elastic member 30 appropriately.

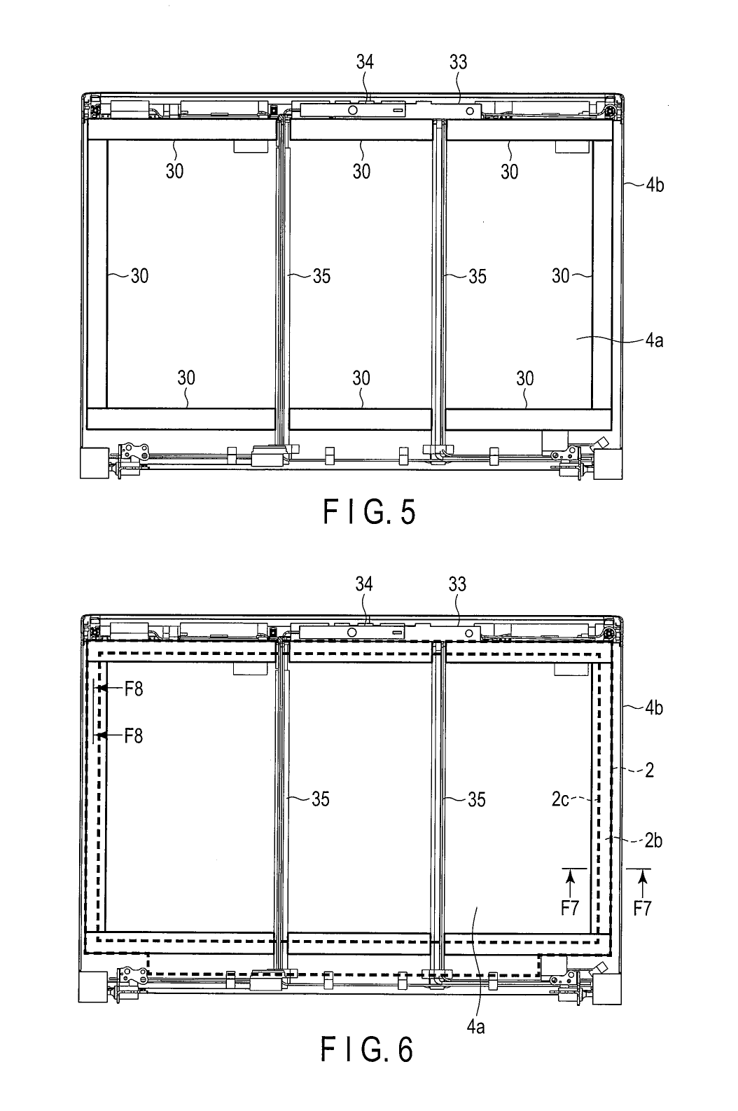

Referring then to FIGS. 5 to 8, the structure and function of each elastic member 30 will be described in detail.

FIG. 5 is a schematic view illustrating a state in which the elastic members 30 are attached to the inner surface of the bottom 4a of the backside cover 4. FIG. 6 is a plan view similar to FIG. 5, in which the outline of the display unit 2 and the edge 2c of the reinforcing frame 2b are additionally indicated by the broken lines. Further, FIG. 7 is a fragmentally sectional view taken along line F7-F7 of FIG. 6, and FIG. 8 is a fragmentally sectional view taken along line F8-F8 of FIG. 6.

As shown in FIGS. 5 and 6, the elastic members 30 are arranged substantially continuously along the inner edge 2c of the reinforcing frame 2b. In the embodiment, since lines 35 to be connected to electronic elements, such as an antenna 33 and a camera 34, which are provided along the side of the backside cover 4 away from the hinges 23, are extended over the inner surface of the bottom 4a of the backside cover 4 as shown in FIGS. 5 and 6, they actually interrupt the continuity of the elastic members 30. However, the elastic members 30 can be regarded as substantially continuous because the width of each line is only several millimeters.

More specifically, as shown in FIG. 7, the reinforcing frame 2b has a U-shaped cross section so that it surrounds the peripheral portion of the display unit 2, and has its annular edge 2c, close to the display screen 2a, arranged in contact with the peripheral edge of the front panel 25. Further, the edge (not shown) of the reinforcing frame 2b close to the backside of the display unit 2 is positioned inward at least relative to the elastic members 30. As shown in FIGS. 6 and 7, the elastic members 30 are arranged in the form of a frame so that they overlap with the edge 2c of the reinforcing frame 2b close to the display screen 2a.

The above-described layout of the elastic members 30 along the edge 2c can prevent significant local deformation of the display unit 2 in a direction in which the display unit 2 is pressed, when the peripheral portion of the display panel 24 is pressed in the direction via the mask 6. As a result, damage of the front panel 25 can be avoided, which may occur due to concentration of stress caused by the pressing at the boundary of the front panel 25 and the edge 2c of the reinforcing frame 2b, the boundary being considered relatively weak in mechanical strength.

In contrast, if the elastic members 30 are arranged inside or outside the edge 2c of the reinforcing frame 2b so that they do not overlap with the edge 2c, damage may well occur at the boundary of the front panel 25 and the edge 2c because of concentration of stress when a pressing force is applied to the display from the outside of the mask 6. Namely, when a pressing force is exerted on the boundary with no elastic members 30, the front panel 25 is liable to crack at the boundary.

In addition, the elastic members 30 also function as buffer members for holding the display unit 2 in a buffer manner when the note PC 20 drops and receives a strong external impact. To this end, in the embodiment, the elastic members 30 have a two-layer structure. More specifically, a relative hard rubber layer 30a is attached to the inner surface of the bottom 4a of the backside cover 4 by means of double-sided tape, and then a relatively soft sponge layer 30b is attached to the rubber layer.

The elastic members 30 are not limited to the two-layer structure, but may have a structure of three or more layers. For instance, a sponge layer may be attached to a plastic film (insulating film) already attached by the double-sided tape, or a rubber layer may be stacked on the insulating film. In this case, the double sided tape may be regarded as a layer included in each elastic member 30. At any rate, it is desirable that the layer of each elastic member 30 closer to the bottom 4a of the backside cover 4 be harder than that closer to the backside of the display unit 2.

As described above, by forming each elastic member 30 by stacking different materials along the thickness of the display unit 2, each elastic member 30 can be set to a desired hardness, whereby both positioning of the elastic members 30 along the thickness of the display unit 2, and the holding of the elastic members 30 in a buffering manner, can be realized with a satisfactory hardness. Further, by hardening the layer close to the bottom 4a of the backside cover 4, the adhesion of the elastic members 30 with respect to the inner surface of the bottom 4a can be enhanced, thereby enhancing the durability of the elastic members.

Furthermore, if the inner surface of the bottom 4a of the backside cover 4a has a projection 40, such as a rib, as shown in FIG. 8, the portion of an elastic member 30 overlapping with the projection 40 is thinned, whereby a disadvantage that a stronger force is exerted at the projection 40 can be avoided, thereby more reliably preventing, for example, a crack in the front panel 25.

At this time, it is relatively easy to thin part of the thickness of such a single-layer elastic member 30 as shown in FIG. 8. However, if the elastic member 30 is formed of two or more layers, it is not easy to thin the elastic member 30 partially. In this case, it may be possible to vary the thickness of, for example, the double-sided tape used to attach the elastic member 30 to the inner surface of the bottom 4a. Namely, the problem of stress concentration can be eliminated by thinning the double-sided tape at the portion thereof corresponding to the projection 40.

In the television receiver and electronic device according to the above-described at least one embodiment, by virtue of the elastic members 30 overlapping with the edge 2c of the reinforcing frame 2b of the display unit 2, the display unit 2 can be reliably held within the backside cover 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, in the above-described embodiment, elastic members 30 having the same structure are arranged continuously along the edge 2c of the reinforcing frame 2b of the display unit 2. However, the invention is not limited to the above, but the material and/or the layer structure of each elastic member 30 may be modified in accordance with its installation position.

For instance, in FIG. 4, the three elastic members 30 located along the upper edge may be made harder than the other elastic members 30 for the following reason. When the display panel 24 is opened or closed with respect to the PC proper 22, the note PC 20 is generally operated, with the distal end of the display panel 24 away from the hinges 23 held by the hand. Further, when the note PC 20 is carried with the display panel 24 kept open, the distal end of the display panel 24 may be kept to be held by the hand. In this case, it is expected that a stronger force will be exerted on the distal end of the display panel 24 away from the hinges 23, than on the other portions of the note PC 20. In view of this, the elastic members 30 provided at the display end may be formed of, for example, one rubber layer to have a higher hardness and a higher resistance against pressure than the other portions.

What is claimed is:

1. A television receiver comprising:
a display unit comprising a reinforcing frame at a peripheral portion thereof;
a casing containing the display unit; and
an elastic member between the casing and the display unit at a position at which the elastic member overlaps with an inner edge of the reinforcing frame.

2. The television receiver of claim 1, wherein the elastic member is substantially continuous along the inner edge of the reinforcing frame.

3. The television receiver of claim 1, wherein the elastic member has a structure in which a plurality of members formed of different materials are stacked along a thickness direction of the display unit.

4. The television receiver of claim 3, wherein the plurality of members include at least two members formed of materials selected from rubber, sponge, an insulating film, and a double-sided tape used to attach the materials to an inner surface of the casing.

5. The television receiver of claim 3, wherein a member of the plurality of members closer to the casing is formed harder than a member of the plurality of members closer to the display unit.

6. The television receiver of claim 2, wherein when the casing has a projection at an inner surface portion thereof which overlaps with the elastic member, a portion of the elastic member is formed thinner than other portions thereof.

7. An electronic device comprising:
a unit including a reinforcing frame;
a casing receiving the unit; and
an elastic member interposed between the casing and the unit at a position which overlaps with an edge of the reinforcing frame.

8. The electronic device of claim 7, wherein the elastic member is substantially continuous along the inner edge of the reinforcing frame.

9. The electronic device of claim 7, wherein the elastic member has a structure in which a plurality of members formed of different materials are stacked along a thickness direction of the unit.

10. The electronic device of claim 9, wherein the plurality of members include at least two members formed of materials selected from rubber, sponge, an insulating film, and a double-sided tape used to attach the materials to an inner surface of the casing.

11. The electronic device of claim 9, wherein a member of the plurality of members closer to the casing is formed harder than a member of the plurality of members closer to the unit.

12. The electronic device of claim 8, wherein when the casing has a projection at an inner surface portion thereof which overlaps with the elastic member, a portion of the elastic member is formed thinner than other portions thereof.
